(19) United States
(12) Patent Application Publication
(10) Pub. No.: US 2005/0055124 A1
(43) Pub. Date: Mar. 10, 2005

(54) Positioning probe and its control system

(75) Inventor: Tung Choi Cheng, Markham (CA)

Correspondence Address: CYM GRAPHICS INC., 1271 DENISON ST., UNIT 47, MARKHAM, ON, L3R 4B5, CA

(73) Assignee: Cym Graphics Inc., Markham (CA)

(21) Appl. No.: 10/653,884

(22) Filed: Sep. 4, 2003

(51) Int. Cl. G06F 19/00

(52) U.S. Cl. 700/160; 700/195

(57) ABSTRACT

A device that detects oncoming objects when contact is made between the probe and the electrically conducting object. The probe is held on the chuck of the rotatable spindle of the lathe machine in a position parallel to the longitudinal axis. The longitudinal axis has a position that is perpendicular to the inserting portion of the chuck. The object is then moved in a vector parallel to the probe. A detected position value and pausing motor movement is occurred when the stage of the voltage is changed in the sensor head of the positioning probe. The positioning probe is a cavity cylinder metal rod having multiple surfaces to allow for the different angles that an object could touch the surface of the probe.

### REFERENCES CITED

U.S. PATENT DOCUMENTS

| | | | |
|---|---|---|---|
| 4320580 | March 1982 | Williams | 33/185R |
| 4428055 | January 1984 | Kelley et al | 364/474 |
| 4562392 | December 1985 | David, et al | 318/572 |
| 4879817 | November 1989 | McMurtry | 33/502 |
| 5819429 | October 1998 | Matsuhashi | 33/558 |
| 5959489 | September 1999 | Walck | 327/333 |

### BACKGROUND OF THE INVENTION

The present invention relates to the positioning probe and its control system that are used for detecting a dimension or position of a work piece and pausing motor movement.

Automation is a widely engaging aspect in the manufacturing industry. A lathe machine with computer numerical control is used in cutting a work piece. The work piece is mounted on a chuck and is attached to the rotational axis of a spindle. A cutting tool is inserted into a tool holder and secured on a turret. The turret carries the cutting tool to move in the Y-axis then forward in the X-axis to cut the work piece. In order to improve the cutting quality, to enhance efficiency and reduce set-up time, most lathe machine is furnished with a touch sensor or probe to perform the process.

In U.S. Pat. No. 4,879,847, refers to the designing of a probe to measure positions. The device retrieves the position information through a series mechanical action spring contact, balls and cylinders that react to a series of electrical connection. The mechanic design was complex and the production cost was expensive.

### BRIEF SUMMARY OF THE INVENTION

The object of the invention uses a more economical and efficient mechanics to build the positioning probe that equips on to the longitudinal axis of the machine. Further, it is an object of the invention to provide an accurate and efficient method to detect a position value for measuring a dimension or a position of a work piece when contact stage is occurred. Furthermore, it is an object of the invention to provide an accurate and efficient method to pause the motor movement when contact has occurred.

In one preferred embodiment of the invention the positioning probe is a cavity cylinder metal rod having multiple surfaces to allow different directions and angles of an electrically conducting object to make contact on the surface of the positioning probe. The object assembles with two cylinders to form metal rods that are a sensor head and a supporter. Sensor head means a cylindrical cavity that allows different angles of the tip of the cutting tool to contact sensor head surface. Cutting tool is an electrical conducting object which has a sharp edge at the tip of the front; the tip is the first portion to contact the sensor head or work piece. Supporter means two different diameters in a rod; the narrow side is a tail for holding, the wide side is connected to the media. Media means a non-conducting round nylon shape which is placed between the sensor head and the supporter to fasten together the different length screws. Two plugs are indented in the sensor head to connect the electrical conducting wire to the control system.

In a further embodiment of the invention the positioning probe utilize an optical signal to determine of contact positioning and motor control. Initially, the sensor head of the positioning probe has a given positive voltage from a power source. Other than the sensor head, all conducting components connected to the lathe machine are grounded to a zero voltage. When contact has taken place between the sensor head and the cutting tool, the voltage on sensor head is dropped to zero voltage. The signal is interrupted in the control system then the motor control is terminated its movement and the detected position value is stored in control center of the control system to be used. Detected position value means the last position signal received from the measuring device when sensor head and electrically conducting object is in contact.

### BRIEF DESCRIPTION OF THE DRAWINGS

Embodiments of the invention will now be described by way of examples only and with reference to the accompanying drawings wherein:

FIG. 1 is an explanatory plan view of the positioning probe and its control system.

FIG. 2 is a front view of the positioning probe.

FIG. 3 is top view of the media and the supporter.

FIG. 4 is a side view of the sensor head and the shape of cutting tools.

FIG. 5 is a front view of this invention being equipped in a lathe machine.

FIG. 6 top view of the carriage table.

### DETAILED DESCRIPTION OF A PREFERRED EMBODIMENT

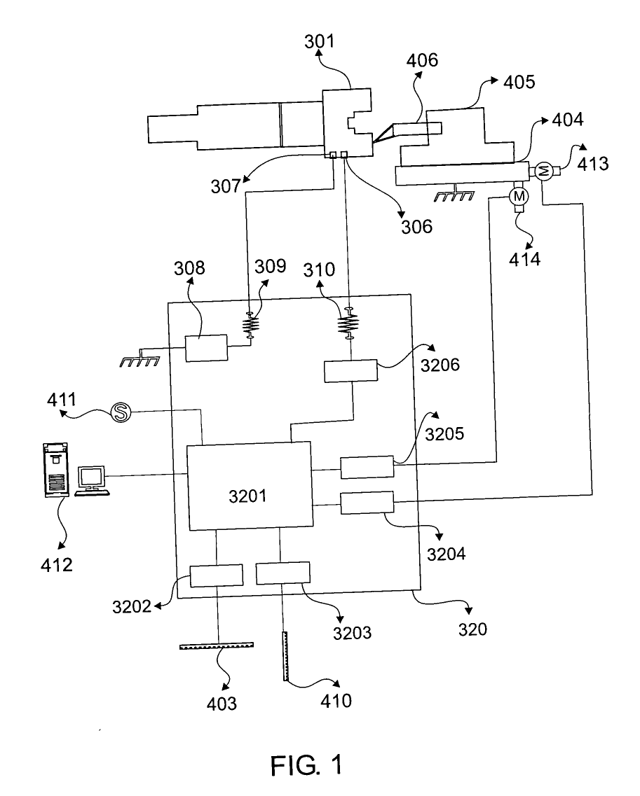

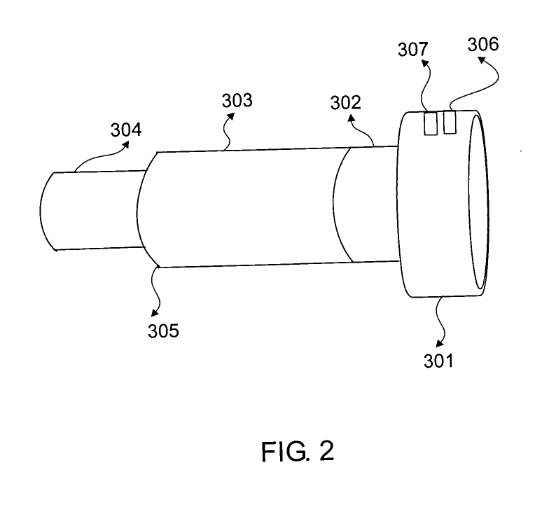

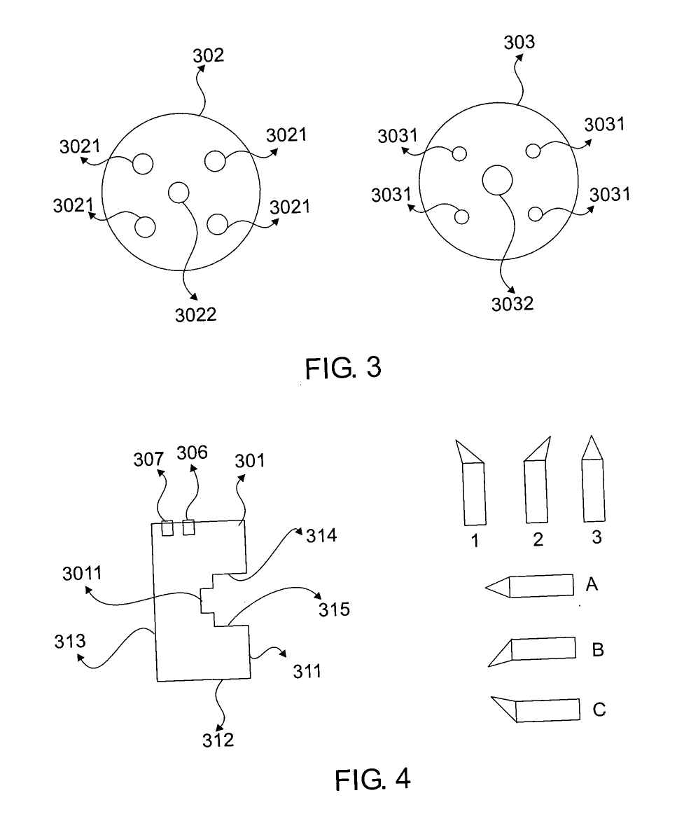

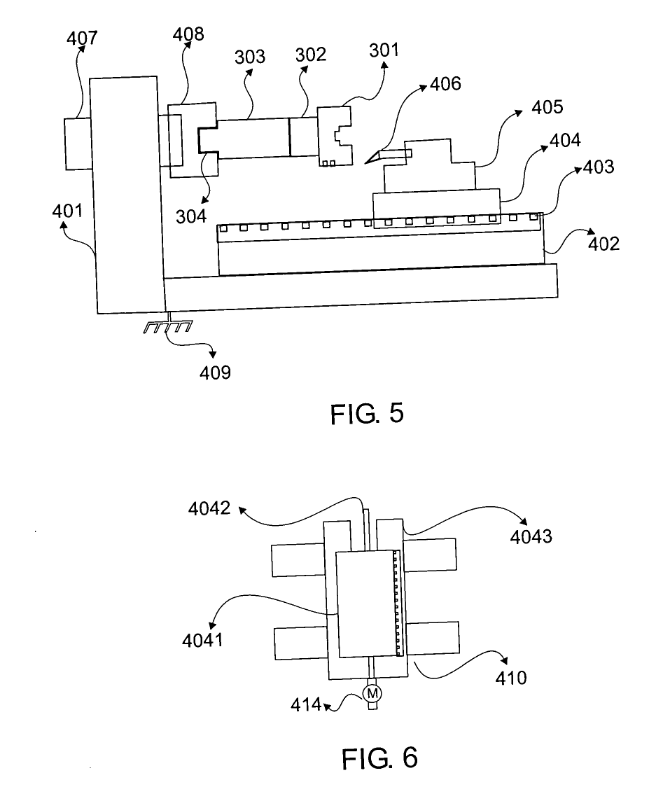

The preferred embodiment of the present invention will be described hereinafter in accordance with FIG. 1, FIG. 2, FIG. 3, FIG. 4, FIG. 5 and FIG. 6. Reference numbers of the same components are identical across all figures.

Referring to the drawings FIG. 2, shows the composition of the positioning probe 300. The supporter 303 has two difference dimensions. The thicker diameter on the right of the supporter 303 is directly connected to the media 302, whereas the thinner diameter is a tail 304 on the left of the supporter 303 to capably hold on by the jaws of the chuck 408 (show in FIG. 5). The tail mark 305 is a guide line to insert the tail 304 completely into the jaw of the chuck 408. Tail mark 305 means the intersection between thicker and thinner diameter and is perpendicular to the surface of the probe.

Referring to the drawing FIG. 3, the four screw holes 3031 of the supporter 303 correspond to the positions of the four holes 3021 of the media 302 at the point at which they are fasten together. The holes 3011 (show in FIG. 4) of the sensor head 301, 3022 of the media 302 and 3032 of the supporter 303 which are each located at the centre of each of their respective parts, align vertically at the same center point. Meaning their positions corresponds to each other at the point in which they are fastened together. The sensor head 301 has a screw that is inserted through the hole 3011 to the screw hole 3022 of the media 302 which secures the parts together but without contacts to the hole 3032 of the supporter 302. The hole of 3032 of the support 302 is slightly bigger than the hole of 3022 of the media 302 to assure the inserted screw from the sensor head 301 to the media 302 is never in contact to the supporter 303. Two plugs 306 and 307 are indentions in the sensor head 301 for connecting electrical conducting wire to the control system 320. The sensor head 301 (show in FIG. 4) have multiple diameters on its axle, their diameter are perpendicular surfaces and linearly aligned at the same center point of the sensor head 301.

The sensor head 301 has multiple surface diameters that are used to capably contact different directions and angles of the tip of the cutting tool 406. Referring to the drawing FIG. 4 are examples of the tip of the cutting tool 406 in different direction and angles that are capable of contacting the particular surface of the sensor head 301 to execute the detecting position. The illustration shows directions of the cutting tools that have the same orientation to insert the tool holder of the turret 405.

Surface 311 for the cutting tool A, B, C and 1, 3 to measure X axis direction.

Surface 312 for the cutting tool 1, 2, 3 to measure Y axis direction.

Surface 313 for the cutting tool 2 to measure X axis direction.

Surface 314 for the cutting tool C to measure Y axis direction.

Surface 315 for the cutting tool B to measure Y axis direction.

Referring to the drawings FIG. 5 show the construction and their relative components of the lathe machine 401. A rototable spindle 407 connects with a chuck 408 which includes a set of jaws for holding. The spindle axis is positioned parallel to the lathe bed 402. The positioning probe 300 is held by the chuck 408 for position detecting.

Lathe bed 402 has a pair of guide rods and a rack that are placed perpendicular in relation to the X axis of the lathe machine 401. The carriage table 404 perpendicularly saddles across the lathe bed. The motor 413 (show in FIG. 1) moves along the rack and is capable of moving forward and backward along the X axis.

A linear scale 403 mounts parallel at the back of the guide rod of the lathe bed 402. The sensor head of the linear scale uses a bracket to mount on the carriage table 404 that is capable of moving in positions in X axis. Linear scale means the measuring device that can emit position signals through a sensor head along its rod. Position signal is an electrical pulse.

Referring to the FIG. 6, the carriage table 404 contains a saddle casting 4043 connect with a cross feed screw 4042 that is driven by the motor 414 to move front and back of Y axis direction. A cross-slider 4041 is a perpendicular mount on top of the saddle casting 4043. Another linear scale 410 with its sensor head mounts linearly beside of the cross-slider 4041 and is capable of moving in the Y-axis along the saddle casting 4043. A turret includes a tool holder 405 capable of inserting a cutting tool that is carried by carriage table 405 which is mounted on the cross-slider 4041.

Referring to the drawing FIG. 1, herewith defines the functions of the component in the control system 320. Two MCU (micro control units) 3202 and 3203 receive position signals that are emitted from the linear scale 403 of the X axis to the MCU-store 3202 and the linear scale 410 of the Y axis to the MCU-store 3203. After analyzing and organizing those signals, the signals are then converted to a position value that is stored in the control center 3201. A PC Computer 412 and a manual control stop button 411 are capable of emitting a stop signal to the control center 3201. Either one of the signals from the PC Computer 412 and the manual control stop button 411 are emitted then the motors of 413 and 414 will cease to function. In addition, the PC Computer 412 also emits a pass-by signal to the control center if positioning probe 300 is not connecting on the lathe. The control center 3201 is a data exchange center to organize all data inputting and outputting.

An optical coupler 3206 includes a LED (light emitting diodes) and a light transistor. A circuit flows through the resistor 309 in serial from the power source 308 to the plug 307 that supplies a positive voltage to the sensor head 301. The current then passes through the resistor 310 that is connected in serial via the plug 306 to load the LED that generates a light signal. The light signal shines on the light transistor which then transmits an electrical signal to the control center 3201. This electrical signal means move-signal is stored in control center 3201 for MCU-move to detecting.

The MCU-move 3204 controls the motor 413 of its X axis movement and the MCU-move 3205 controls the motor 414 of its Y axis movement. For every movement, either the MCU-moves of 3204 or 3205 has to monitor difference kinds of signals and read the position value in the control center 3201 then compare the position value to a programmed target position X or Y for determinate the stage of movement. In particular, MCU-move 3204 will compare its value to the programmed target position of X; MCU-move 3205 will compare its value to the programmed target position of Y. The steps of the monitoring include:

(a) monitor the pass-by signal of the PC Computer 412, if is on, then go to the (b), otherwise check the move-signal is available or not. If yes, then go next, otherwise quit the proceeding;

(b) monitor the stop signal of PC Computer 412 is available. If not, then go to next, otherwise quit the proceeding;

(c) monitor the stop signal of the stop 411 is available. If not, then go to next, otherwise quit the proceeding;

(d) read position value of MCU-store 3202 or 3203 and compare to the programmed target position. If the value is difference then the motor is moved, otherwise the program ends.

Quit the proceeding means suspend the process, and then waits for the PC computer for further commands. End of program means the process of positioning detecting is complete but there was no contact between the positioning probe 300 and the cutting tool.

When the power on, as illustrated in the drawing FIG. 1 shows the lathe machine 401 is physically ground to earth. All metal components that are connected to the lathe machine have a zero voltage.

Herewith three stages are relative to the positioning detecting and motor control. The positioning probe 300 is held by the chuck 408 of the spindle 407. The circuit flows to the resistor 309 that is in serial with the power source 308 to the plug 307 for supplying the positive voltage to the sensor head 301. The power source's zero voltage is connected to the ground. In addition, the circuit through the plug 306 via the resistor 310 is in series connection with the optical coupler. Then the current loads the LED to illuminate the light transistor to produce an electrical signal that is transmitted to the control center 3201. This signal is retained in the control center 3201 as a flag for MCU-move monitoring. At this stage there is non-contact.

The turret with the tool holder 405 that is the cutting tool 406 inserted is carried by carriage table 405, which is driven by motors. The position signals emitted from the linear scales 403 of X axis to MCU-store 3202 and 410 of Y axis to MCU-store 3203 are stored in the control center 3201. Those signals store in the control center 3201 are represented of X and Y axis's position value and will be change and override from the movement of the carriage table 405 until detected position value occurs.

Once the tip of the cutting tool 406 is moved along on X and Y axis of the lathe machine, then in contact to the surface of sensor head 301. The sensor head 301 of the positioning probe 300 then short the voltage to ground. In other words, the voltage has changed to zero volts form the sensor head 301 of the positioning probe 300. At the result, the move-signal sent from optical coupler 3206 to the control center 3201 is terminated. In other words, the flag retain in control center 3201 is lose. This is the stage of means contact.

Thus, the signal emitted from optical coupler 3206 to the control center 3201 is interrupted. Either the MCU-moves 3204 or MCU-move 3205 cannot detect move-signal in the control center 3201 then abort all further processing means the motor movement is paused.

Meanwhile, the position value stored in the control center 3201 is by means of the detected position value when the contact stage is occurred. In particular, when the contact stage is occurred, any of linear scale is not emitted position signal for the carriage table 404 is not move. This is the stage of detected position value.

In another situation, the position probe 300 may be inserted to the cutting holder of the turret 405 for position detecting. The work piece holds on the chuck 408 of the spindle 407. The positioning probe 300 is inserted to the tool holder of the turret carry by the carriage table to forward to contact the work piece. The work piece is defined as an electrically conducting object. When the sensor head 301 of the positioning probe is in contact of the work piece, the sensor head 301 is shorts the voltage to ground. Then, the move-signal sent from optical coupler 3206 to the control center 3201 is terminated. In other words, the flag retain in control center 3201 is lose. This is the stage of means contact.

Thus, the signal emitted from optical coupler 3206 to the control center 3201 is interrupted. Either the MCU-moves 3204 or MCU-move 3205 cannot detect move-signal in the control center 3201 then abort all further processing that means the motor movement is paused.

Meanwhile, the position value stored in the control center 3201 is by means of the detected position value when the contact stage is occurred.

It should be apparent that the preceding description illustrates the current invention in one embodiment only and the invention is not restricted to the preferred embodiment. It should also be evident to those skilled in that art that variations and modifications to the preferred embodiment are possible without departing from the spirit and scope of the design. In particular, it should be understood that the invention can embody the sensor head 301 have multiple diameters on its axis a sensor head 301 of positioning probe 300 positioned in any direction and the number of different diameters on sensor head are not limited to the described preferred embodiment.

Further, it should be understood that the invention can embody the power source 308 to supply positive or negative voltage in direct current (DC) or positive voltage and negative voltage in alternating current (AC). When alternating current utilizes for supply power source to sensor head, one or more LED and capacity will be add to the circuit.

1. A positioning probe to be used for detecting a dimension or a position of a work piece, comprising of:
sensor head means multiple diameters for an electrically conducting object to be able to make contact;
supporter means multiple diameters for able to be held on to;
media defining a non-conducting element between said sensor head and said supporter;
plug defining the connection of the electrical conducting wire to the said sensor head;

2. The positioning probe according to claim 1 wherein said sensor head's edge are generated by slopes of the increment between said multi diameters of said sensor head, and all these edges are in right angles meaning all said slopes approach infinity.

3. The positioning probe according to claim 1 wherein said supporter's edges are generated by slopes of the increment between said multi diameters of said supporter, and all these edges are in right angles meaning all said slopes approach infinity.

4. The positioning probe according to claim 1 wherein said:
all multi dimensions of said sensor head are at the same center point;
said media aligns center point to center with said sensor head;
said support aligns center point to center with said sensor head.

5. A control system for monitoring the condition of a move-signal and providing a detected position value and motor control to be used for detecting a dimension or position of a work piece and pausing motor movement to a machine; at least one pair of MCU and relative components are integrated in the control system. The stages of the said control system comprise of;
non-contact means providing said move-signal retain in the control center for monitoring and determining a motor movement;
contact means said move-signal is lost in said control center to cause pausing of the motor movement;
detected position value means said contact is occurred, the position value stored in the control centre is by means of detected position value;

6. A control system according to claim 5 wherein said move-signal is a current through said sensor head then to an optical coupler to generate a signal then transmit to the control center for a MUC (micro control units) to detecting.

7. A control system according to claim 5 wherein said MCU (micro control units); at lease one pair of said MCU is allocated in said control system to input and output data through said control center; those data information is represent of one axis; said input means MCU-store means receiving signal from a measuring device for one axis then converting the position signal to a position value that is stored in said control center; said output means a MCU-move-means said position value is read from said control center of same axis to determine the method of execution for the movement of the same axis' motor; for example if said MCU-store has been inputted with X axis's information then said MCU-move's output follows the same axis of said MCU-store and controls the same axis motor movement; said one axis means one direction either of longitude, latitude or altitude; at lease one pair of said MCU is allocated in said control system means there can be more than one pair of said MCU integrate in control system for said direction

8. A control system according to claim 5 wherein said stage of non-contact, includes the steps of:
power source provides a positive voltage through a resistor that is connected serial to said plug then connected to the sensor head; then
said positive voltage flows through another said plug via another resistor in serial to load a LED (light emitting diode) to said optical coupler; then
said LED emits a light signal to illuminate a light transistor; then
said light signal is convert to an electrical signal by a light transistor to said control centre; said electrical signal means said move-signal; then
said move-signal is retain in said control center for said MCU-move to determinate the method of execution.

9. A control system according to claim 8 wherein said sensor head is isolated by said non-conducting object, which is capable of obtaining a positive voltage from a power source to produce a voltage difference.

10. A control system according to claim 8 wherein said power source which is located in the control system to supply a positive voltage to said sensor head and the power source's zero voltage is connected to the ground.

11. A control system according to claim 8 wherein said power source to supply positive voltage in direct current (DC) for said sensor head.

12. A control system according to claim 8 wherein said power source to supply negative voltage in direct current (DC) for said sensor head.

13. A control system according to claim 8 wherein said power source to supply positive and negative voltage in alternating current (AC) for said sensor head; one or more said LED and capacity to be integrated in said control system.

14. A control system according to claim 8 wherein said resistor is used for current limiting means to protect the said circuit.

15. A control system according to claim 8 wherein said optical coupler includes said LED and said light transistor, said LED transmit said light signal to said light transistor and then generate signal sent to control center.

16. A control system according to claim 5 wherein stage of said contact means any one of said MCU-move is no longer detects a said move-signal in said control centre then said MCU-move quits an execution; the steps that are included:
said sensor head is in contact with said electrical conducting object; then
said sensor head has voltage drop to zero means the voltage is grounded; then
said optical coupler is fail to transmit said move-signal to said control centre; then
said move-signal in said control center is abortion; then
said MCU-move monitor said move-signal cannot detect in said control center; then
said MCU-move quit the execution from said control system means controls the motor movement is suspended movement of driving motor.

17. A control system according to claim 17 wherein said control center means PLD (Programmable Logic Device) to organize and storage command, data and signal input/output to/from said MCU, PC computer and hardware device.

18. A control system according to claim 5 wherein said position value means a position signal emit from said measuring device transmit to said MCU-store to analyze and organize then convert to said position value to store in said control center; said position value to be changed and overridden it's value in said control centre by measuring device's position signal is changed; said position value is changed and overridden by the movement of said measuring device.

19. A control system according to claim 19 wherein said detected position value is means to equal to the position value that store in control center when stage of said contact is occurred.
